(19) United States
(12) Patent Application Publication
(10) Pub. No.: US 2026/0101294 A1
(43) Pub. Date: Apr. 9, 2026

(54) RTC MICRO-SECOND COUNTER

(71) Applicant: STMicroelectronics International N.V., Geneva (CH)

(72) Inventors: Eusebio Di Cola, Messina (IT); Elena Salurso, Mascalucia (IT); Lucio Salvatore Ticli, Aci Bonaccorsi (IT)

(21) Appl. No.: 18/905,318

(22) Filed: Oct. 3, 2024

(51) Int. Cl. H04W 56/00; H04J 3/06; H04W 52/02

(52) U.S. Cl. CPC H04W 56/0015; H04J 3/0658; H04W 52/0287

(57) ABSTRACT

According to an embodiment, maintaining accurate timing in low-power electronic systems using a low-frequency clock source is proposed. A Timing Synchronization Function (TSF) value is calculated for each clock cycle and errors are determined. Periodic corrections are applied based on calculated residual errors to maintain microsecond-level accuracy. The circuit can include multiplexers, an adder, registers, and control logic to implement variable increments and resynchronization. The TSF counter approximates a higher-frequency clock by incrementing by varying amounts on different cycles. This enables precise timing for applications like low-power wireless receivers while minimizing power consumption. The technique allows the use of an efficient low-frequency clock source like a 32 kHz crystal oscillator while achieving the accuracy of a much higher frequency timer.

### TECHNICAL FIELD

The present disclosure generally relates to electronic devices and, in particular embodiments, to a real-time clock (RTC) micro-second counter.

### BACKGROUND

Power consumption reduction has become increasingly important for many electronic devices and systems, particularly in wireless communications and Internet of Things (IoT) applications. As battery-powered devices proliferate, techniques to extend battery life by minimizing power consumption have evolved from simply reducing individual components' static and dynamic power to implementing sophisticated power management schemes at the protocol and system levels.

Power consumption is a critical factor in wireless communication systems, such as Wi-Fi networks, especially for mobile and IoT devices that operate for extended periods on limited battery power. To address this, modern communication protocols incorporate various power-saving modes and techniques. One such technique is using a low-power wake-up radio in addition to the main radio in receiver devices.

A typical wireless system consists of a transmitter and one or more receivers. Each receiver has two components: a main radio for full data packet reception and a low-power wake-up radio that detects wake-up signals. The main radio, which consumes more power, can be turned off during inactivity to conserve energy. The low-power wake-up radio remains active to listen for potential wake-up signals from the transmitter, allowing the system to quickly transition to an active state when communication is desired.

To further reduce power consumption, the wake-up radio often operates in a duty-cycled mode, alternating between brief active listening periods (T_{ON}) and longer sleep periods (T_{OFF}). The approach significantly reduces the receiver's average power consumption. However, it introduces timing challenges, as the wake-up radio is to be precisely synchronized with the transmitter to ensure it is awake and listening when a wake-up signal is sent.

Maintaining accurate timing in such low-power systems presents a challenge. The internal timer or real-time clock (RTC) responsible for managing the duty cycle aims to maintain microsecond-level accuracy to ensure proper synchronization. However, high-frequency clock sources that could provide such accuracy typically consume excessive power to be practical in these applications. Conversely, low-power, low-frequency clock sources like 32 kHz crystals lack the inherent precision for microsecond-level timing.

### SUMMARY

Technical advantages are generally achieved by embodiments of this disclosure, which describe a real-time clock (RTC) micro-second counter.

A first aspect relates to a method for maintaining accurate timing in a low-power electronic system. The method comprising calculating a Timing Synchronization Function (TSF) value for a current cycle using a low-frequency clock source; calculating an error for the current cycle; comparing the error for the current cycle to a previous error; calculating a residual error if the error for the current cycle is less than the previous error; determining correction parameters if the residual error is non-zero; and applying periodic corrections to the TSF value based on the correction parameters.

A second aspect relates to a wireless receiver comprising a low-power timing circuit. The low-power timing circuit configured to calculate a Timing Synchronization Function (TSF) value for a current cycle using a low-frequency clock source, calculate an error for the current cycle, compare the error for the current cycle to a previous error, calculate a residual error if the error for the current cycle is less than the previous error, determine correction parameters if the residual error is non-zero, and apply periodic corrections to the TSF value based on the correction parameters.

A third aspect relates to a circuit for implementing a Timing Synchronization Function (TSF) counter. The circuit comprising a first multiplexer with multiple input lines for different increment values; an adder coupled to the first multiplexer; a TSF counter register coupled to the adder; a last-second value register coupled to the TSF counter register; a second multiplexer coupled to the TSF counter register and the last-second value register; and a control logic circuit coupled to the first multiplexer, the second multiplexer, and the TSF counter register.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of a wireless communication system;

FIG. 2 is a timing diagram of the duty-cycled operation of a receiver;

FIG. 3 is a flowchart of an embodiment method to implement a dedicated TSF (Timing Synchronization Function) counter that guarantees a maximum error less than the desired maximum error value;

FIG. 4 is a timing diagram that demonstrates the implementation of steps 320-350 of the method of FIG. 3 for Real-Time Clock (RTC) using an external crystal oscillator at 32,000 Hz;

FIG. 5 is a block diagram of an embodiment circuit; and

FIG. 6 is a timing diagram that demonstrates the implementation of the method of FIG. 3 for a Real-Time Clock (RTC) using an external crystal oscillator at 32,768 Hz.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the concepts described herein are presented primarily in the context of low-power Wi-Fi applications, it should be appreciated that these concepts may also apply to other timing-sensitive systems facing similar power constraints. In particular, aspects of this disclosure may be relevant to various low-power wireless protocols, Internet of Things (IoT) devices, sensor networks, and other applications where precise timing is desired alongside stringent power limitations. The techniques discussed could benefit any system that requires fine-grained time synchronization but is restricted to using low-frequency clock sources due to, for example, power or cost considerations.

The present disclosure relates to techniques for improving timing accuracy in low-power electronic systems. In embodiments, a technique is provided for generating a high-resolution timer using a low-frequency clock source. The approach involves implementing a process that calculates incremental adjustments to a timer value, allowing for microsecond-level precision despite using a clock with a period much longer than a microsecond.

One aspect of the disclosure involves a real-time clock (RTC) system that can maintain accurate timing using a 32.768 kHz crystal oscillator, commonly used in low-power applications due to its energy efficiency. The system employs a counter incremented at varying intervals to approximate a higher-frequency clock. By carefully controlling the increments, the system can achieve a resolution much finer than the period of the base clock.

In embodiments, the system calculates an optimal sequence of increment values to minimize timing errors. The sequence may involve alternating between different increment values on successive clock cycles. For example, with a 32.768 kHz clock, the counter may be incremented by 30 microseconds on odd cycles and 31 microseconds on even cycles to approximate a 1 MHz timer.

The disclosure describes techniques for periodically correcting accumulated errors. In an embodiment, an additional increment is applied at regular intervals to compensate for small timing discrepancies that build up over time. For example, the system may add 130 microseconds every 5,688 clock cycles to maintain long-term accuracy.

Further, embodiments of the disclosure include a technique for resynchronizing the timer at fixed intervals, such as every second. The resynchronization can involve setting the timer to a predetermined value, eliminating any drift that may have occurred over the previous interval.

The systems and methods described can be implemented in hardware, software, or a combination thereof. Hardware implementations may include dedicated logic circuits designed to efficiently perform the necessary calculations and counter adjustments. Software implementations may utilize a processor executing instructions to perform similar functions, offering greater flexibility at the cost of some additional power consumption.

While particularly well-suited for low-power Wi-Fi applications, the techniques described in this disclosure may apply to a wide range of systems where precise timing is desired in conjunction with low power consumption. These can include various IoT devices, sensor networks, and other wireless communication systems operating under power constraints. These and additional details are further detailed below.

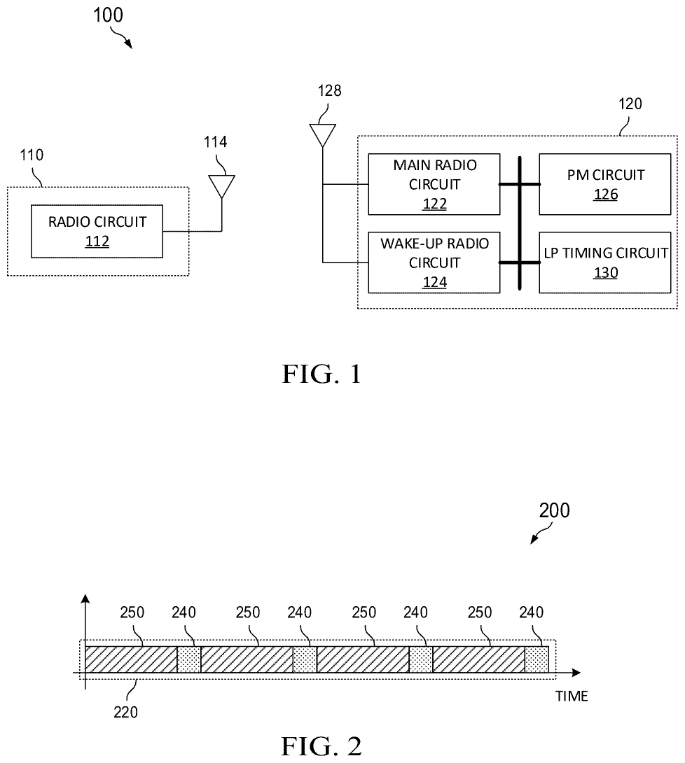

FIG. 1 illustrates a block diagram of a wireless communication system 100, including a transmitter 110 and a receiver 120. The transmitter 110 includes a radio circuit 112 and a transmitter antenna 114, which may (or may not) be arranged as shown. The receiver 120 includes a main radio circuit 122, a wake-up radio circuit 124, a power management circuit 126, a receiver antenna 128, and a low-power timing circuit 130, which may (or may not) be arranged as shown. Transmitter 110 and receiver 120 may include additional components not shown.

Transmitter 110 is configured to communicate with the receiver 120 in active and low-power modes. In embodiments, the radio circuit 112 operates in multiple modes. It functions as a main transmitter during active communication, sending data packets to the receiver 120. During low-power periods, the radio circuit 112 can generate wake-up signals designed to be detected by the receiver 120 when in a low-power state. The radio circuit 112 is coupled to the transmitter antenna 116, which radiates data packets and wake-up signals into the wireless medium.

On the receiver side, the main radio circuit 122 can process full data packets and support high-speed communication with the transmitter 110. However, it typically consumes significant power when active. To conserve energy, the receiver 120 incorporates the wake-up radio circuit 124, designed to operate with much lower power consumption than the main radio circuit 122.

The wake-up radio circuit 124 is optimized to detect wake-up signals sent by the transmitter 110. It remains active during low-power periods when the main radio circuit 122 is powered down. The main radio circuit 122 and the wake-up radio circuit 124 are coupled to the receiver antenna 128, allowing them to receive signals from the transmitter 110. In embodiments, the functions of the main radio circuit 122 and the wake-up radio circuit 124 are combined into a single multi-mode radio circuit, similar to the radio circuit 112.

The power management circuit 126 controls the power states of various components within the receiver 120. It can selectively enable or disable the main radio circuit 122 and the wake-up radio circuit 124 based on the current operating mode and detected signals. The power management circuit 126 is coupled to the main radio circuit 122 and the wake-up radio circuit 124 and can respond to wake-up events detected by the wake-up radio circuit 124.

In embodiments, the power management circuit 126 ensures that the main radio circuit 122 and the wake-up radio circuit 124 operate mutually exclusively. When the receiver 120 is in its low-power state, the main radio circuit 122 is powered off to conserve energy, while the wake-up radio circuit 124 is enabled and operates in its duty-cycled mode. Conversely, when the main radio circuit 122 is activated for full data communication, the wake-up radio circuit 124 is typically powered down, as its function is not needed during active data transfer.

The low-power timing circuit 130 is coupled to the wake-up radio circuit 124 and the power management circuit 126. It maintains accurate time synchronization with the transmitter 110 despite operating with a low-frequency clock to conserve power. The low-power timing circuit 130 enables the wake-up radio circuit 124 to operate in a duty-cycled manner, periodically activating to listen for wake-up signals and then returning to a low-power state.

When the transmitter 110 is ready to initiate communication with the receiver 120, it sends a wake-up signal using the radio circuit 112. The wake-up radio circuit 124, operating in its duty-cycled mode, periodically activates for short listening windows as determined by the low-power timing circuit 130. If the wake-up radio circuit 124 detects a wake-up signal during one of these listening windows, it triggers the power management circuit 126 to activate the main radio circuit 122. Once the main radio circuit 122 is active, the transmitter 110 can send data packets using its radio circuit 112. These data packets are received and processed by the now-active main radio circuit 122 in the receiver 120.

The system architecture allows power savings in the receiver 120 during periods of inactivity while maintaining the ability to resume full communication quickly when needed. The low-power timing circuit 130 ensures that the wake-up radio circuit 124 activates at the correct times to receive potential wake-up signals, balancing the need for power efficiency with reliable communication.

FIG. 2 illustrates a timing diagram 200 of the duty-cycled operation of receiver 120 in the wireless communication system 100. The timing diagram 200 includes a receiver timeline 220, receiver ON periods (T_{ON}) 240, and receiver OFF periods (T_{OFF}) 250.

The receiver timeline 220 represents the time axis for receiver 120, illustrating its duty-cycled operation controlled by the low-power timing circuit 130. The receiver ON periods (T_{ON}) 240 represent the active listening windows of the wake-up radio circuit 124, while the receiver OFF periods (T_{OFF}) 250 show when it's in a low-power state.

The low-power timing circuit 130 in receiver 120 functions as a Real-Time Clock (RTC) and implements a Timing Synchronization Function (TSF). The TSF can be realized through a counter inside the RTC to maintain synchronization with the transmitter 110. The TSF counter maintains a microsecond-resolution timer that defines the precise timing of the receiver ON periods (T_{ON}) 240 and the receiver OFF periods (T_{OFF}) 250 for the wake-up radio circuit 124.

The timing diagram 200 shows the alternating pattern of receiver ON periods (T_{ON}) 240 and receiver OFF periods (T_{OFF}) 250. The timing duration of the receiver ON periods (T_{ON}) 240 and receiver OFF periods (T_{OFF}) 250 directly impacts the power consumption of the wireless communication system 100. Longer receiver OFF periods (T_{OFF}) 250 result in lower average power consumption but increase the latency of wake-up detection.

In embodiments, the low-power timing circuit 130 determines the duration and frequency of the periods. Typically, the receiver ON periods (T_{ON}) 240 are shorter than the receiver OFF periods (T_{OFF}) 250, reflecting the system's power-saving approach.

The receiver ON periods (T_{ON}) 240 are typically set to accommodate the longest expected wake-up packet plus any necessary calibration time. Wake-up packets can range from, for example, about one to a few milliseconds in duration, depending on the type and related payload. As a result, receiver ON periods (T_{ON}) 240 are often fixed to a value near ten milliseconds to ensure reliable reception.

The low-power timing circuit 130 in the receiver 120 implements the TSF to maintain synchronization with the transmitter 110. The TSF maintains a microsecond-resolution timer that defines the precise timing of the ON and OFF periods for the wake-up radio circuit 124. The TSF counter inside the RTC continuously increments, with its value determining the start and end of each of the receiver ON periods (T_{ON}) 240 and the receiver OFF periods (T_{OFF}) 250. The TSF counter typically rolls over at a large value, such as 264, providing a long period before repetition.

The TSF counter's accuracy, in addition to being advantageous for minimizing the error between its value and the transmitter's clock, also prevents long-term drift between the two timers. A small, consistent drift can lead to significant misalignment over time. For example, if we consider a slot time of 10 milliseconds for the receiver ON periods (T_{ON}) 240, a fixed 100 microsecond error between the two timers might not cause significant issues as the wake-up packet would still arrive within the ON window. However, if the error accumulates over time, even at one nanosecond per clock pulse, after 1,000,000 clock pulses, the error would grow to one millisecond and continue increasing, eventually causing the receiver 120 to miss wake-up signals.

Accordingly, the challenge addressed by the embodiments of this disclosure is finding a compromise between the need for microsecond-scale TSF timer granularity and the power constraints that preclude using a highly accurate clock source (e.g., using a 1 MHz clock source for a 32 KHz application).

In embodiments, the low-power timing circuit 130 implements a technique to maintain the TSF counter with microsecond-level accuracy despite the RTC using a low-frequency clock source, such as a 32.768 kHz crystal oscillator, instead of a 1 MHz clock source. The proposed mechanism involves incrementing the TSF counter by varying amounts on different clock cycles of the RTC. For example, with a 32.768 kHz clock, the TSF timer may be incremented by 30 microseconds on odd cycles and 31 microseconds on even cycles, approximating the behavior of a 1 MHz timer.

In embodiments, the low-power timing circuit 130 periodically applies additional corrections to maintain the TSF's long-term accuracy. These can include adding an extra increment at regular intervals (e.g., 130 microseconds every 5,688 clock cycles) and performing a full resynchronization every second by setting the TSF timer to a predetermined value.

The power management circuit 126 uses the TSF value from the low-power timing circuit 130 to control the wake-up radio circuit 124. It activates the wake-up radio circuit 124 when the TSF timer reaches specific values corresponding to the start of the receiver ON periods (T_{ON}) 240. It deactivates it when the TSF timer indicates the end of the period. The precise control ensures that the wake-up radio circuit 124 is active when necessary, minimizing power consumption while maintaining the ability to receive wake-up signals.

Advantageously, the TSF-based timing scheme enabled by the low-power timing circuit 130 allows the receiver 120 to operate in a highly power-efficient manner while maintaining the ability to respond quickly to wake-up signals from the transmitter 110. The accurate synchronization of the TSF, maintained by the low-power timing circuit 130, ensures reliable communication initiation, even with the receiver spending most of its time in a low-power state.

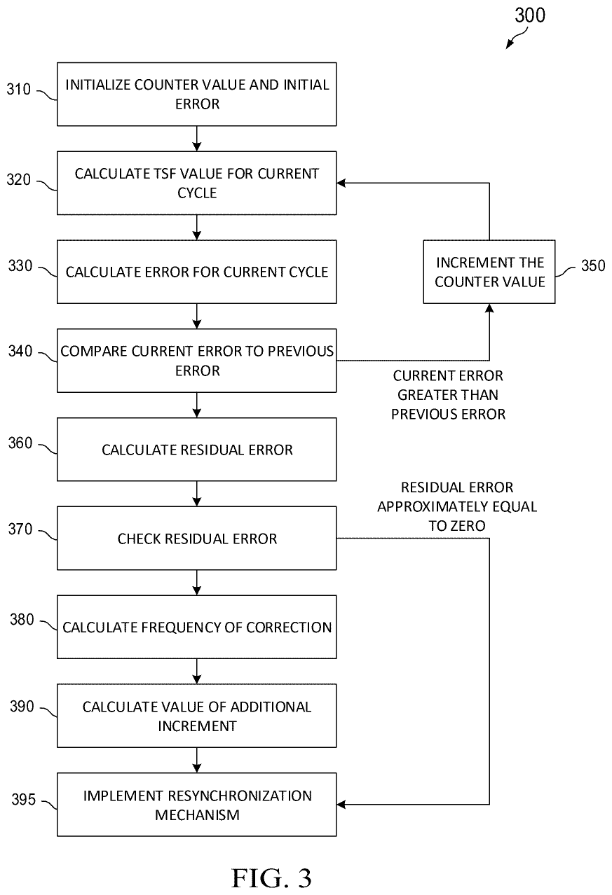

FIG. 3 illustrates a flowchart of an embodiment method 300 to implement a dedicated TSF (Timing Synchronization Function) counter that guarantees a maximum error less than the desired maximum error value. It is noted that all steps outlined in the flow chart of method 300 are not necessarily required and can be optional. Further, changes to the arrangement of the steps, removal of one or more steps and path connections, and addition of steps and path connections are similarly contemplated.

Step 310 initializes the counter value (N) and the initial error. In an embodiment, the counter value (N) is set to one, and the initial error is set to zero.

At step 320, the TSF value for the current cycle is calculated. In embodiments, the calculation involves multiplying the clock period by the counter value (N) and taking the integer part of the result. Here, “clock period” refers to the period of the low-frequency clock being used, such as a 32.768 kHz crystal oscillator. For example, the period of the 32.768 kHz clock is approximately 30.52 microseconds (1/32768 seconds).

The TSF value (TSFᵥₐₗᵤₑ) can be expressed as: TSFᵥₐₗᵤₑ(N)=INT(N×Period), where TSFᵥₐₗᵤₑ(N) is the calculated value for the TSF counter at the N^{th} cycle, INT( ) represents the integer function (which truncates any fractional part), N is the current cycle number (starting from 1), and Period is the clock period (e.g., about 30.52 microseconds for a 32.768 kHz clock).

The TSF calculation aims to approximate the behavior of a higher-frequency clock using the low-frequency clock source. By taking the integer part, method 300 ensures that the TSF counter increments in whole microsecond steps, even though the actual time elapsed may include a fractional part of a microsecond. The approach allows the system to maintain microsecond resolution while using a clock with a much longer period.

At step 330, the error for the current cycle is calculated by finding the difference between the actual time (i.e., N multiplied by the period) and the TSF value calculated in step 320. The error (Error) can be calculated using the equation: Error(N)=(N×Period)−TSFᵥₐₗᵤₑ(N).

The error calculation quantifies the discrepancy between the ideal high-resolution timer and the approximation achieved using the low-frequency clock. Method 300 uses the calculated error to determine when to apply corrections and how large those corrections should be.

At step 340, method 300 enters a loop, comparing the current error to the previous error. If the current error is less than or equal to the previous error, method 300 transitions to step 360. However, if the current error is greater than the previous error, method 300 transitions to step 350, where the counter value (N) is incremented, and the method returns to step 320. The loop continues until the error decreases, at which point, the method 300 transitions to step 360.

At step 360, the residual error is calculated in nanoseconds. This step transforms the cumulative error over N cycles into an average error per cycle, providing a more useful metric for subsequent calculations and corrections.

In embodiments, the calculation involves dividing the final error by the counter value (N) and multiplying by 1000 to convert to nanoseconds. The residual error can be expressed as

$${RESIDUAL}_{ERROR} = \frac{Error ( N )}{N} \times 1000 ,$$

where RESIDUAL_{ERROR} is the calculated residual error in nanoseconds, Error(N) is the final error value obtained when the loop in steps 320-350 terminates, N is the final counter value when the loop terminates, and 1000 is the factor to convert from microseconds to nanoseconds.

The residual error represents the average error per clock cycle in nanoseconds. This value is used to determine if further corrections are needed and, if so, how to apply them. If the residual error is zero, the TSF counter is perfectly synchronized with the ideal high-frequency timer. However, a non-zero residual error indicates that additional corrections may be necessary to maintain long-term accuracy.

Step 370 checks if the calculated residual error is zero. If the condition is true, the TSF counter is perfectly synchronized with the ideal high-frequency timer, and no further corrections are needed. In this case, method 300 transitions to step 395.

However, if the residual error is not zero, it indicates a small discrepancy between the TSF counter and the ideal timer. While small for a single cycle, the discrepancy can accumulate over time, leading to significant timing errors. Therefore, if the residual error is non-zero, the method proceeds to step 380 to calculate additional corrections.

In practical implementations, achieving exactly zero residual error may be rare due to the limitations of floating-point arithmetic and the nature of the low-frequency clock. Therefore, the comparison might involve checking if the absolute value of the residual error is below a very small threshold rather than exactly zero. The threshold can be determined based on the system's specific requirements and the precision of the calculations.

Step 380 calculates the frequency at which the correction will be applied to keep the error below the maximum allowed error. The calculation can be expressed as

$${Increment}_{PULSE} = \frac{{MAX}_{ERROR} \times 1000}{{RESIDUAL}_{ERROR}} ,$$

where Increment_{PULSE} is the number of clock pulses after which an additional increment should be applied and MAX_{ERROR} is the maximum allowed error in microseconds (a predefined value based on system requirements).

The frequency calculation determines how many clock pulses should occur before applying an additional increment to the TSF counter to prevent the accumulation of errors.

At step 390, the value of the additional increment is determined. The calculation can be expressed as

$${Increment}_{COUNT} = \frac{{Increment}_{PULSE} \times {RESIDUAL}_{ERROR}}{1000} ,$$

where Increment_{COUNT} is the value of the additional increment in microseconds.

Calculating the value of the additional increment ensures that, when applied at the frequency determined in step 380, it will compensate for the accumulated error over time.

Steps 380 and 390 allow the system to make periodic adjustments to the counter value, preventing the gradual drift that would otherwise occur due to the mismatch between the low-frequency clock and the desired high-resolution timer.

Step 395 implements a resynchronization mechanism to ensure long-term accuracy of the TSF counter. This step can be expressed as TSF_{COUNTER}=LAST_SECOND_{VALUE}+1,000,000, where TSF_{COUNTER} is the current value of the TSF counter, LAST_SECOND_{VALUE} is the value of the TSF counter exactly one second ago, and 1,000,000 represents one second in microseconds.

In the example of the 32.768 kHz crystal oscillator, the resynchronization is performed every 32,768 clock cycles (corresponding to one second for the 32.768 kHz clock). The process involves storing the TSF counter value at the beginning of each one-second interval, adding 1,000,000 to the stored value after 32,768 clock cycles have elapsed, and setting the current TSF counter to this newly calculated value.

The mechanism serves several purposes. First, it corrects any accumulated errors not fully addressed by the previous correction steps. Second, it ensures that the TSF counter accurately represents the passage of time in microseconds, regardless of any small discrepancies in the previous calculations. Finally, it prevents long-term drift by providing a fixed reference point every second.

The choice of one second as the resynchronization interval balances the need for frequent corrections with the desire to minimize the impact on normal timer operations. This step advantageously maintains synchronization with external time references and ensures that the TSF counter remains accurate over extended periods of operation.

Method 300 is adaptable to various clock frequencies while maintaining its core functionality. When implemented with different frequency clock sources, it can adjust its calculations accordingly, always preserving the fundamental timing relationship. For example, regardless of the input clock frequency, it maintains the principle of incrementing the TSF counter by 1,000,000 microseconds (equivalent to one second) at regular intervals.

In embodiments, the consistent second-based resynchronization is a feature that can remain constant across different frequency implementations. The specific increment values and the frequency of additional corrections can vary depending on the input clock frequency, but the overall structure and goals of the method remain intact. The flexibility allows method 300 to be applied in a wide range of low-power applications with varying clock speed requirements while still providing accurate microsecond-level timing.

Method 300 allows for precise timing synchronization using a low-frequency clock source, effectively balancing the need for accuracy with power efficiency. It dynamically adjusts the counter increments and periodically applies corrections to prevent long-term drift. The method is particularly useful in systems where minimizing power consumption is an important feature, such as in low-power wireless devices, as it enables using a low-frequency clock while maintaining microsecond-level accuracy.

Accordingly, method 300 addresses the challenge of maintaining accurate timing when using a clock source with a period much longer than the desired timer resolution. By calculating and applying variable increments and periodic corrections, method 300 can approximate the behavior of a higher-frequency clock while consuming significantly less power.

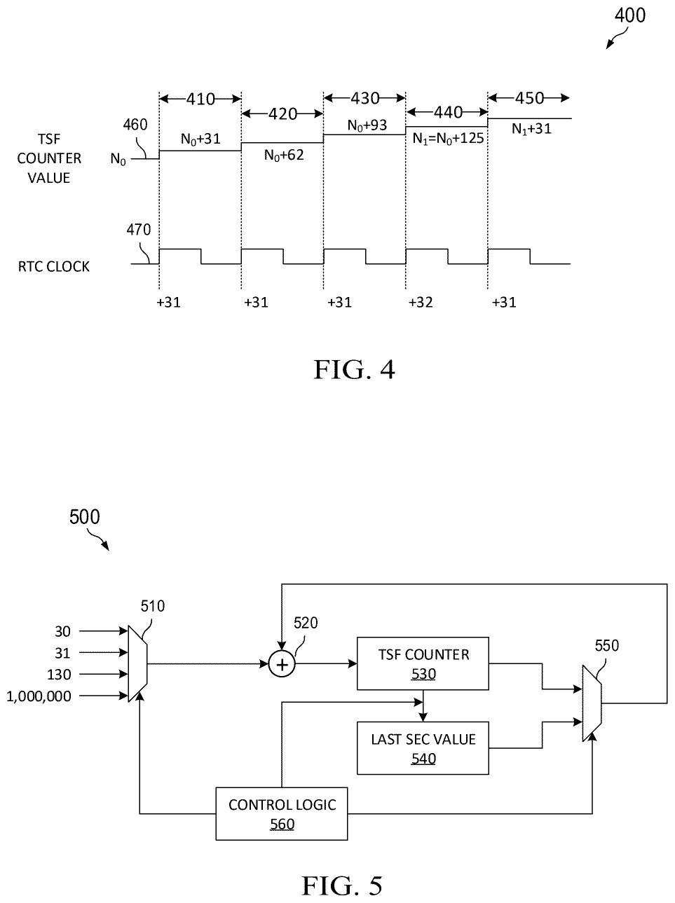

FIG. 4 illustrates a timing diagram 400 that demonstrates the implementation of steps 320-350 of method 300 for Real-Time Clock (RTC) using an external crystal oscillator at 32,000 Hz. The timing diagram 400 shows how the TSF counter is incremented to approximate a higher-frequency clock using the low-frequency source, aligning with the calculations performed in steps 320 and 330 of method 300.

The RTC clock period is 1/32000 seconds, or approximately 31.25 microseconds, corresponding to the ‘Period’ value used in method 300. In this example, four RTC clock pulses equate to 125 microseconds.

Timing diagram 400 depicts five clock pulses (the first four clock pulses for the first period and the first clock pulse for the next period), with the TSF counter increments for the first four pulses (first pulse 410, second pulse 420, third pulse 430) shown as TSF+31 for the first three pulses and TSF+32 for the fourth pulse 440.

The incrementing pattern relates to the calculations performed in steps 320 and 330 of method 300, where the TSFᵥₐₗᵤₑ (N) and Error (N) are calculated for each cycle. By incrementing by 31 microseconds for three cycles and then 32 microseconds for the fourth cycle, the counter achieves an average increment of 31.25 microseconds per cycle, matching the actual clock period and minimizing the error calculated in step 330.

The TSF counter value signal 460 illustrates the cumulative effect of the increments on the TSF counter value over time, starting from 0 and progressing to N+31, N+62, N+93, and finally N+125 after the fourth pulse. The progression demonstrates how the loop in steps 340 and 350 of method 300 iterate, continuously calculating and adjusting the TSF value to maintain accuracy.

The 32 kHz clock signal 470 provides a visual reference for the relationship between the physical clock pulses and the TSF counter increments. The relationship illustrates how method 300 achieves microsecond-level accuracy using a lower-frequency clock source to maintain precise timing while minimizing power consumption in low-power applications.

The values 31 and 32 shown correspond to the inputs of the first multiplexer 510 in the subsequent circuit diagram (FIG. 5), illustrating how the theoretical timing calculations of method 300 are translated into practical hardware implementation. This figure thus bridges the algorithmic approach outlined in method 300 and the hardware realization depicted in FIG. 5.

FIG. 5 illustrates a block diagram of an embodiment circuit 500. In embodiments, circuit 500 implements the steps outlined in method 300. Circuit 500 includes a first multiplexer 510, an adder 520, a TSF counter register 530, a LAST_SECOND_{VALUE} register 540, a second multiplexer 550, and a control logic circuit 560, which may (or may not) be arranged as shown. Circuit 500 may include additional components not shown.

The first multiplexer 510 has multiple input lines, including lines for the values 31 and 32. These values correspond to the increment amounts determined in steps 320-350 of method 300. The first multiplexer 510 selects between these inputs based on signals from the control logic circuit 560, which implements the logic of step 340.

The adder 520 has two inputs: one from the first multiplexer 510 and another from the second multiplexer 550. It adds the selected increment value to the value provided by the second multiplexer 550, performing the calculations described in steps 320 and 330 of method 300.

The TSF counter register 530 stores the current value of the TSF counter, corresponding to the TSFᵥₐₗᵤₑ (N) in method 300. It receives updated values from the adder 520 and outputs the current TSF value to the second multiplexer 550 and the LAST_SECOND_{VALUE} register 540.

In embodiments, the TSF counter register 530 is configured to allow external access to its value. This can be achieved through an alternative function of a general-purpose input/output (GPIO) pin. Such a feature enables real-time monitoring and verification of the internal timer value, particularly useful for testing and debugging. By exposing the TSF counter value, it becomes possible to compare the system's actual timing behavior with the expected behavior, ensuring that the low-power timing circuit 130 is functioning as intended.

The LAST_SECOND_{VALUE} register 540 stores the TSF counter value from one second ago, receiving the value from the TSF counter register 530. This implements the LAST_SECOND_{VALUE} storage for the resynchronization process described in step 395 of method 300.

The second multiplexer 550 receives inputs from the TSF counter register 530 and the LAST_SECOND_{VALUE} register 540. Based on signals from the control logic circuit 560, it selects between these inputs. It provides its output to the adder 520, facilitating normal increments and resynchronization as described in steps 380-395 of method 300.

The control logic circuit 560 coordinates the operation of the components, implementing the decision-making logic described in steps 340, 370, and 395 of method 300. It determines which increment value to use, when to perform resynchronization, and manages the overall timing of the circuit.

In normal operation, corresponding to steps 320-350 of method 300, the control logic circuit 560 signals the first multiplexer 510 to select the appropriate increment value (e.g., 31 for the first three clock cycles, 32 for the fourth). The second multiplexer 550 selects the current TSF value from the TSF counter register 530. The adder 520 adds these two values, implementing steps 320 and 330, and the result is stored in the TSF counter register 530.

For resynchronization, corresponding to step 395 of method 300, the control logic circuit 560 signals the second multiplexer 550 to select the value from the LAST_SECOND_{VALUE} register 540. This value (plus 1,000,000) is then fed to the adder 520 along with the appropriate increment from the first multiplexer 510. The result updates the TSF counter register 530, implementing the TSF_{COUNTER}=LAST_SECOND_{VALUE}+1,000,000 calculation.

Advantageously, circuit 500 efficiently implements the TSF counter with microsecond-level accuracy while using a low-frequency clock source to minimize power consumption.

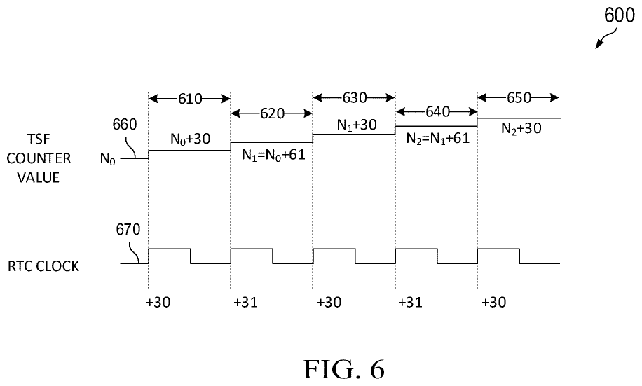

FIG. 6 illustrates a timing diagram 600 that demonstrates the implementation of method 300 for a Real-Time Clock (RTC) using an external crystal oscillator at 32,768 Hz, demonstrating how circuit 500 implements the method 300 to maintain accurate timing while keeping the maximum error below 100 microseconds. In many applications, an external crystal oscillator operating at 32,768 Hz is a standard frequency for low-speed clocks

Here, the RTC clock period is 1/32768 seconds or approximately 30.517578125 microseconds. This value corresponds to the base clock cycle (i.e., period) with which the circuit 500 works. The first multiplexer 510 in circuit 500 alternates between selecting 30 and 31 as increment values for odd and even clock pulses, respectively. This is represented in the diagram by the alternating “TSF+30” (for first pulse 610, third pulse 630, and fifth pulse 650) and “TSF+31” increments (for the second pulse 620 and the fourth pulse 640). The alternating pattern is derived from the calculations in steps 320-350 of method 300, optimizing the increment values to minimize error.

The TSF counter register 530 value increases over time. Starting from an initial value N, TSF counter value signal 660 progresses to N+30, N+61 (N+30+31), and so on. The progression demonstrates how the adder 520 in circuit 500 applies the alternating increments to closely approximate the ideal time progression.

An additional feature shown is the increment of +130 applied every 5,688 clock pulses. In circuit 500, this can be implemented by the first multiplexer 510 by selecting the 130 input at these intervals, as directed by the control logic circuit 560. This addresses the residual error of about 17.6 ns that accumulates every clock pulse, preventing it from growing to almost 18 microseconds after a thousand clock pulses.

Further, timing diagram 600 indicates a resynchronization phase occurring every 32,768 clock pulses (one second). In circuit 500, this can be achieved when the control logic circuit 560 signals the second multiplexer 550 to select the value from the LAST_SECOND_{VALUE} register 540, and the first multiplexer 510 to select 1,000,000. The adder 520 then adds these values, effectively setting the TSF counter register 530 to the old value from one second ago plus 1,000,000 microseconds.

Timing diagram 600 advantageously shows how the components of circuit 500 work together to implement method 300, adapting to the 32,768 Hz clock frequency while maintaining high accuracy. It demonstrates the practical application of the various steps of method 300, including basic increments, additional corrections, and periodic resynchronization, all working in concert to achieve microsecond-level precision using a low-frequency clock source.

A first aspect relates to a method for maintaining accurate timing in a low-power electronic system. The method comprising calculating a Timing Synchronization Function (TSF) value for a current cycle using a low-frequency clock source; calculating an error for the current cycle; comparing the error for the current cycle to a previous error; calculating a residual error if the error for the current cycle is less than the previous error; determining correction parameters if the residual error is non-zero; and applying periodic corrections to the TSF value based on the correction parameters.

In a first implementation form of the method, according to the first aspect as such, calculating the TSF value comprises multiplying a clock period by a counter value and taking an integer part of the result.

In a second implementation form of the method, according to the first aspect as such or any preceding implementation form of the first aspect, calculating the error for the current cycle comprises finding a difference between an actual time and the calculated TSF value.

In a third implementation form of the method, according to the first aspect as such or any preceding implementation form of the first aspect, the method further comprising incrementing a counter value and recalculating the TSF value and the error for the current cycle in response to the error for the current cycle being greater than or equal to the previous error.

In a fourth implementation form of the method, according to the first aspect as such or any preceding implementation form of the first aspect, calculating the residual error comprises dividing a final error by a counter value and converting the result to nanoseconds.

In a fifth implementation form of the method, according to the first aspect as such or any preceding implementation form of the first aspect, determining the correction parameters comprises calculating a frequency at which corrections will be applied and a value of additional increments.

In a sixth implementation form of the method, according to the first aspect as such or any preceding implementation form of the first aspect, the method further comprising performing a resynchronization by setting the TSF value to a sum of a previous TSF value from one second ago and 1,000,000 microseconds.

A second aspect relates to a wireless receiver comprising a low-power timing circuit. The low-power timing circuit configured to calculate a Timing Synchronization Function (TSF) value for a current cycle using a low-frequency clock source, calculate an error for the current cycle, compare the error for the current cycle to a previous error, calculate a residual error if the error for the current cycle is less than the previous error, determine correction parameters if the residual error is non-zero, and apply periodic corrections to the TSF value based on the correction parameters.

In a first implementation form of the wireless receiver, according to the second aspect as such, the low-power timing circuit implements the TSF using a counter inside a Real-Time Clock (RTC).

In a second implementation form of the wireless receiver, according to the second aspect as such or any preceding implementation form of the second aspect, the counter is incremented by varying amounts on different clock cycles to approximate a higher-frequency clock.

In a third implementation form of the wireless receiver, according to the second aspect as such or any preceding implementation form of the second aspect, calculating the TSF value comprises multiplying a clock period by a counter value and taking an integer part of the result.

In a fourth implementation form of the wireless receiver, according to the second aspect as such or any preceding implementation form of the second aspect, calculating the error for the current cycle comprises finding a difference between an actual time and the calculated TSF value.

In a fifth implementation form of the wireless receiver, according to the second aspect as such or any preceding implementation form of the second aspect, the low-power timing circuit is further configured to increment a counter value and recalculate the TSF value and the error for the current cycle in response to the error for the current cycle being greater than or equal to the previous error.

In a sixth implementation form of the wireless receiver, according to the second aspect as such or any preceding implementation form of the second aspect, the low-power timing circuit is configured to maintain microsecond-level accuracy while using the low-frequency clock source.

A third aspect relates to a circuit for implementing a Timing Synchronization Function (TSF) counter. The circuit comprising a first multiplexer with multiple input lines for different increment values; an adder coupled to the first multiplexer; a TSF counter register coupled to the adder; a last-second value register coupled to the TSF counter register; a second multiplexer coupled to the TSF counter register and the last-second value register; and a control logic circuit coupled to the first multiplexer, the second multiplexer, and the TSF counter register.

In a first implementation form of the circuit, according to the third aspect as such, the first multiplexer is configured to select between different increment values based on signals from the control logic circuit.

In a second implementation form of the circuit, according to the third aspect as such or any preceding implementation form of the third aspect, the adder is configured to add a selected increment value to a value provided by the second multiplexer.

In a third implementation form of the circuit, according to the third aspect as such or any preceding implementation form of the third aspect, the TSF counter register is configured to store a current value of the TSF counter and output the current value to the second multiplexer and the last-second value register.

In a fourth implementation form of the circuit, according to the third aspect as such or any preceding implementation form of the third aspect, the circuit is configured to perform a resynchronization by setting the TSF counter register to a sum of a value from the last-second value register and 1,000,000 microseconds.

In a fifth implementation form of the circuit, according to the third aspect as such or any preceding implementation form of the third aspect, the control logic circuit is configured to coordinate operation of the circuit to maintain accurate timing using a low-frequency clock source.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A method for maintaining accurate timing in a low-power electronic system, the method comprising:
calculating a Timing Synchronization Function (TSF) value for a current cycle using a low-frequency clock source;
calculating an error for the current cycle;
comparing the error for the current cycle to a previous error;
calculating a residual error if the error for the current cycle is less than the previous error;
determining correction parameters if the residual error is non-zero; and
applying periodic corrections to the TSF value based on the correction parameters.

2. The method of claim 1, wherein calculating the TSF value comprises multiplying a clock period by a counter value and taking an integer part of the result.

3. The method of claim 1, wherein calculating the error for the current cycle comprises finding a difference between an actual time and the calculated TSF value.

4. The method of claim 1, further comprising incrementing a counter value and recalculating the TSF value and the error for the current cycle in response to the error for the current cycle being greater than or equal to the previous error.

5. The method of claim 1, wherein calculating the residual error comprises dividing a final error by a counter value and converting the result to nanoseconds.

6. The method of claim 1, wherein determining the correction parameters comprises calculating a frequency at which corrections will be applied and a value of additional increments.

7. The method of claim 1, further comprising performing a resynchronization by setting the TSF value to a sum of a previous TSF value from one second ago and 1,000,000 microseconds.

8. A wireless receiver comprising a low-power timing circuit, the low-power timing circuit configured to:
calculate a Timing Synchronization Function (TSF) value for a current cycle using a low-frequency clock source,
calculate an error for the current cycle,
compare the error for the current cycle to a previous error,
calculate a residual error if the error for the current cycle is less than the previous error,
determine correction parameters if the residual error is non-zero, and
apply periodic corrections to the TSF value based on the correction parameters.

9. The wireless receiver of claim 8, wherein the low-power timing circuit implements the TSF using a counter inside a Real-Time Clock (RTC).

10. The wireless receiver of claim 9, wherein the counter is incremented by varying amounts on different clock cycles to approximate a higher-frequency clock.

11. The wireless receiver of claim 8, wherein calculating the TSF value comprises multiplying a clock period by a counter value and taking an integer part of the result.

12. The wireless receiver of claim 8, wherein calculating the error for the current cycle comprises finding a difference between an actual time and the calculated TSF value.

13. The wireless receiver of claim 8, wherein the low-power timing circuit is further configured to increment a counter value and recalculate the TSF value and the error for the current cycle in response to the error for the current cycle being greater than or equal to the previous error.

14. The wireless receiver of claim 8, wherein the low-power timing circuit is configured to maintain microsecond-level accuracy while using the low-frequency clock source.

15. A circuit for implementing a Timing Synchronization Function (TSF) counter, the circuit comprising:
a first multiplexer with multiple input lines for different increment values;
an adder coupled to the first multiplexer;
a TSF counter register coupled to the adder;
a last-second value register coupled to the TSF counter register;
a second multiplexer coupled to the TSF counter register and the last-second value register; and
a control logic circuit coupled to the first multiplexer, the second multiplexer, and the TSF counter register.

16. The circuit of claim 15, wherein the first multiplexer is configured to select between different increment values based on signals from the control logic circuit.

17. The circuit of claim 15, wherein the adder is configured to add a selected increment value to a value provided by the second multiplexer.

18. The circuit of claim 15, wherein the TSF counter register is configured to store a current value of the TSF counter and output the current value to the second multiplexer and the last-second value register.

19. The circuit of claim 15, wherein the circuit is configured to perform a resynchronization by setting the TSF counter register to a sum of a value from the last-second value register and 1,000,000 microseconds.

20. The circuit of claim 15, wherein the control logic circuit is configured to coordinate operation of the circuit to maintain accurate timing using a low-frequency clock source.
